(19) United States
(12) Patent Application Publication
(10) Pub. No.: US 2025/0078658 A1
(43) Pub. Date: Mar. 6, 2025

(54) ATTENTION GUIDANCE DEVICE, ATTENTION GUIDANCE SYSTEM, AND PROGRAM

(71) Applicant: HONDA MOTOR CO., LTD., Tokyo (JP)

(72) Inventors: Vanessa KRUEGER, Offenbach am Main (DE); Matti KRUEGER, Offenbach am Main (DE); Taisuke MUKAI, Saitama (JP)

(21) Appl. No.: 18/587,966

(22) Filed: Feb. 27, 2024

(30) Foreign Application Priority Data
Mar. 10, 2023 (CN) 202310229254.X

(51) Int. Cl. G08G 1/16; B60K 35/22; B60K 35/23; B60K 35/81

(52) U.S. Cl. CPC G08G 1/16; B60K 35/22; B60K 35/23; B60K 35/81

(57) ABSTRACT

An attention guidance device according to an embodiment includes a detector, a calculator, and a display controller. The detector detects an object around a mobile object. The calculator calculates a level of risk of contact between the mobile object and the detected object using at least one of an action or a state of an operator of the mobile object. The display controller controls and causes a display to display a representation using parameters determined according to the level of risk of contact in such a manner that a direction of the detected object from the operator's perspective is recognizable.

This application is based on and claims the benefit of priority from Chinese Patent Application No. 202310229254.X., filed on 10 Mar. 2023, the content of which is incorporated herein by reference.

### BACKGROUND OF THE INVENTION

### Field of the Invention

The present invention relates to an attention guidance device, an attention guidance system, and a program.

### Related Art

It is known in the art to notify a driver of a mobile object, such as a vehicle, of the danger of the mobile object coming into contact with another object. Examples of such technologies include forward collision warning (FCW), head-up warning (HUW), and park distance control (PDC).
Patent Document 1: Japanese Unexamined Patent Application, Publication No. 2016-196289

### SUMMARY OF THE INVENTION

The aforementioned technologies provide notifications regardless of the driver's state. Therefore, the technologies may provide a notification unnecessary for the driver in some situations.

An object of an embodiment of the present invention is to provide an attention guidance device, an attention guidance system, and a program that make it possible to vary the manner in which risk of contact between a mobile object and another object is notified, according to at least one of an action or a state of an operator of the mobile object.

An attention guidance device according to an embodiment includes a detector, a calculator, and a display controller. The detector detects an object around a mobile object. The calculator calculates a level of risk of contact between the mobile object and the detected object using at least one of an action or a state of an operator of the mobile object. The display controller controls and causes a display to display a representation using parameters determined according to the level of risk of contact in such a manner that a direction of the detected object from the operator's perspective is recognizable.

The present invention makes it possible to vary the manner in which risk of contact between a mobile object and another object is notified, according to at least one of an action or a state of an operator of the mobile object.

### BRIEF DESCRIPTION OF THE DRAWINGS

FIG. 1 is a diagram showing an example of a configuration of the interior of a vehicle cabin in a vehicle according to an embodiment;

FIG. 2 is a plan view of the vehicle according to the embodiment as seen from above;

FIG. 3 is a block diagram showing an example of main components of the vehicle according to the embodiment;

FIG. 4 is a flowchart showing an example of processing to be executed by a processor shown in FIG. 3;

FIG. 5 is a diagram for describing a display position on a display;

FIG. 6 is a diagram showing, in chronological order, an example of display content that is displayed in a display section of the display; and

FIG. 7 is a diagram for describing change of the display position and change of the display content of an object representation.

### DETAILED DESCRIPTION OF THE INVENTION

The following describes a vehicle according to an embodiment with reference to the accompanying drawings. It should be noted that the elements shown in the drawings to be used for the description of the embodiment below may not be true to scale. Furthermore, the drawings to be used for the description of the embodiment below may show some configurations in a streamlined manner for ease of explanation. In the drawings and the present specification, identical reference numerals identify similar elements.

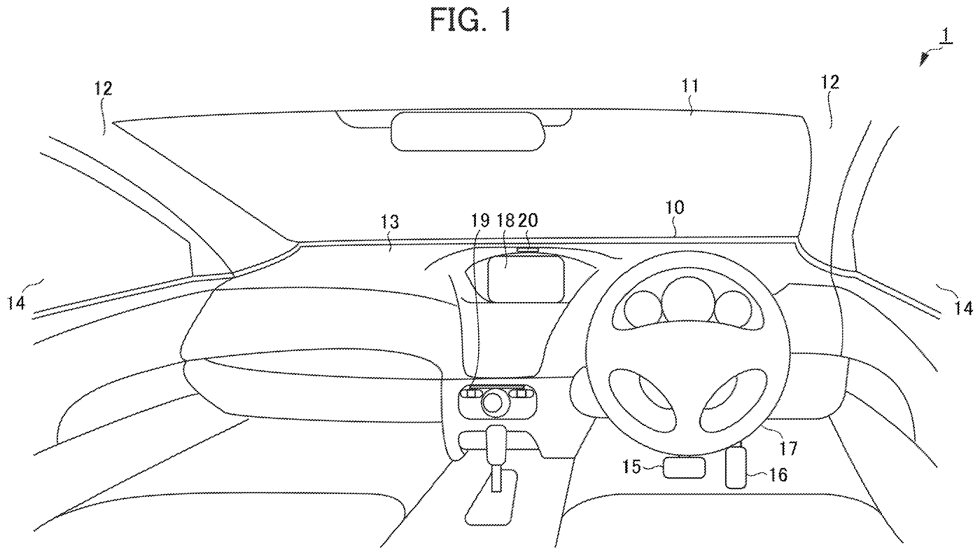

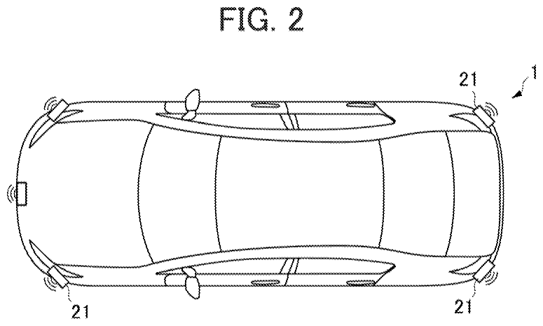

The following describes an example of a configuration of a vehicle 1 with reference to FIGS. 1 and 2. FIG. 1 is a diagram showing an example of a configuration of the interior of a vehicle cabin in the vehicle 1 according to the present embodiment. It should be noted that FIG. 1 depicts the interior of the vehicle cabin as seen from the rear toward the front. FIG. 2 is a plan view of the vehicle 1 according to the present embodiment as seen from above.

The vehicle 1 is, for example, an automobile. The vehicle 1 is, for example, a manually-driven vehicle. Alternatively, the vehicle 1 may be a semi-autonomous driving vehicle or a fully autonomous driving vehicle. The vehicle 1 may be an electric vehicle or a non-electric vehicle in which, for example, the power is generated in an internal combustion engine. The vehicle 1 includes, for example, a display 10, a windshield 11, A-pillars 12, an instrument panel 13, side windows 14, an accelerator pedal 15, a brake pedal 16, a steering wheel 17, a display device 18, an input device 19, an in-vehicle sensor 20, and an external sensor 21. It should be noted that the vehicle 1 is an example of what is referred to as a mobile object. The vehicle 1 is also an example of what is referred to as an attention guidance system.

The A-pillars 12 include an A-pillar 12R and an A-pillar 12L. The two A-pillars 12 are an example of a pair of members that hold left and right sides of the windshield. The A-pillar 12R is a right-side A-pillar 12. The A-pillar 12L is a left-side A-pillar 12.

The display 10 notifies a driver of the vehicle 1 or other occupants of various information. The display 10 is, for example, disposed on the instrument panel 13 or between the windshield 11 and the instrument panel 13. The display 10 is, for example, disposed between the A-pillar 12R and the A-pillar 12L. The display 10 has, for example, a horizontal length that extends from the A-pillar 12R to the A-pillar 12L. Alternatively, the display 10 may have a length that reaches locations on the A-pillars 12. Alternatively, the display 10 may have a length that extends beyond the A-pillars 12 and reaches the side windows 14. The display 10 shown in FIG. 1 has a length that reaches the side windows 14. Alternatively, the display 10 may have a length that reaches areas beyond the side windows 14. For example, the display 10 may reach locations on the rear side. Alternatively, the display 10 may be disposed so as to surround the driver 360 degrees in all directions. The display 10 may be disposed only in portions of the vehicle 1 that have windows, such as the windshield 11 and the side windows 14, avoiding portions that have no windows, such as the A-pillars 12. The display 10 may be divided into a plurality of sections, and thus disposed in different portions. It should be noted that the driver is an example of what is referred to as an operator of a mobile object.

The display 10 having at least a horizontal length extending from the A-pillar 12R to the A-pillar 12L is an example of what is referred to as a notification device disposed in a portion of a mobile object that includes an area extending from one of a pair of members holding left and right sides of a windshield of the mobile object to the other.

The display 10 is, for example, a light-emitting device that emits light using a light source such as an incandescent light bulb, an LED, or an organic electroluminescent (EL) device. The light-emitting device has, for example, a structure including one or more rows of light sources arranged in a longitudinal direction. Alternatively, the display 10 may be, for example, a head-up display (HUD) including a projector that projects an image or light onto at least one of the windshield 11 or the side windows 14. In a configuration in which the display 10 is an HUD, the display 10 projects an image or light onto, for example, lower portions of the windshield 11 and the side windows 14. Alternatively, the display 10 may be a liquid crystal display or an organic electro-luminescent (EL) display. The display 10 may be a transparent display embedded in at least a lower portion of at least one of the windshield 11 or the side windows 14. The display 10 may be a combination of some of the following: a light emitting device, an HUD, and other display equipment. For example, a portion of the display 10 on the windshield 11 and the side windows 14 may be an HUD, and a portion of the display 10 on each A-pillar 12 may be a light emitting device.

Regarding the windshield 11, the A-pillars 12, the instrument panel 13, the side windows 14, the accelerator pedal 15, the brake pedal 16, and the steering wheel 17, description of elements of configuration similar to those in a known configuration may be omitted.

The display device 18 displays a screen for notifying the driver of the vehicle 1 or other occupants of various information. The display device 18 is, for example, a display such as a liquid-crystal display or an organic EL display.

The input device 19 receives operations by the driver of the vehicle 1. The input device 19 is, for example, switches, a keypad, a touch pad, or a controller. The input device 19 may be a voice-input device. A touch panel may be used as the display device 18 and the input device 19. In this case, a display panel of the touch panel functions as the display device 18. A touch input-based pointing device of the touch panel functions as the input device 19.

The in-vehicle sensor 20 is used to detect conditions inside the vehicle 1. The in-vehicle sensor 20 detects, for example, the driver's conditions as the conditions inside the vehicle, such as the driver's line of sight, posture, heart rate, and respiratory rate. The in-vehicle sensor 20 is a sensor that includes, for example, a camera or an infrared sensor. The in-vehicle sensor 20 may be a combination of different sensors.

The external sensor 21 is used to detect conditions outside the vehicle 1. The external sensor 21 detects, for example, the position and the speed of objects outside the vehicle. Examples of such objects include other vehicles, pedestrians, buildings and structures such as road signs, traffic lights, guardrails and utility poles. The position of an object includes, for example, the direction and the distance of the object with respect to the vehicle 1. The speed relative to the vehicle 1 or the ground speed may be detected as the speed of an object. The external sensor 21 is a sensor that includes, for example, a camera, a radar, a light detection and ranging (LIDAR) sensor, or an infrared sensor. The external sensor 21 may be a combination of different sensors.

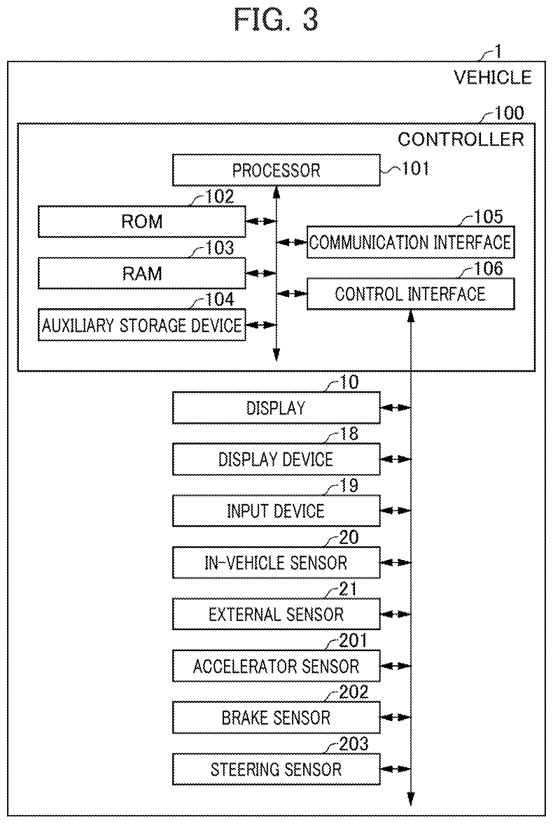

FIG. 3 is a block diagram showing an example of main components of the vehicle 1 according to the present embodiment. In addition to the components described above, the vehicle 1 includes a controller 100, an accelerator sensor 201, a brake sensor 202, and a steering sensor 203. The controller 100 controls the components of the vehicle 1. The controller 100 is, for example, an electronic control unit (ECU). The controller 100 includes, for example, a processor 101, read-only memory (ROM) 102, random-access memory (RAM) 103, an auxiliary storage device 104, a communication interface 105, and a control interface 106. It should be noted that the controller 100 is an example of what is referred to as an attention guidance device.

The processor 101 is the processing center of a computer that performs processing, such as computation and control, necessary for operation of the vehicle 1. The processor 101 performs, for example, various computation and processing. The processor 101 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 101 is a combination of some of the devices mentioned above. The processor 101 may alternatively be a combination of any of the devices mentioned above and a hardware accelerator, for example. The processor 101 controls components of the vehicle 1 to implement various functions of the vehicle 1 based on programs such as firmware, system software, and application software stored in the ROM 102 or the auxiliary storage device 104. The processor 101 also performs processes described below based on the programs. Some or all of the programs may be incorporated in a circuit of the processor 101.

The ROM 102 and the RAM 103 are main storage devices of the computer having the processor 101 as its processing center. The ROM 102 is non-volatile memory that is used exclusively for reading out data. The ROM 102 stores, for example, the firmware among the programs mentioned above. The ROM 102 also stores, for example, data to be used by the processor 101 in performing various processes. The RAM 103 is used for reading and writing data. The RAM 103 is used as, for example, a work area for storage of data to be temporarily used by the processor 101 in performing various processes. Typically, the RAM 103 is volatile memory.

The auxiliary storage device 104 is used by the computer having the processor 101 as its processing center. The auxiliary storage device 104 is, for example, electric erasable programmable read-only memory (EEPROM), a hard disk drive (HDD), or flash memory. The auxiliary storage device 104 stores, for example, the system software and the application software among the programs mentioned above. The auxiliary storage device 104 also stores information such as data to be used by the processor 101 in performing various processes, data generated through the processes performed by the processor 101, and various setting values.

The communication interface 105 is used by the vehicle 1 for communication via, for example, a network NW.

The control interface 106 is used for communication with other components of the vehicle 1. The controller 100 obtains information from components of the vehicle 1 via the control interface 106. The controller 100 also controls components of the vehicle 1 via the control interface 106. Examples of components of the vehicle 1 include the display 10, the display device 18, the input device 19, the in-vehicle sensor 20, the external sensor 21, the accelerator sensor 201, the brake sensor 202, and the steering sensor 203.

The accelerator sensor 201 measures the degree of acceleration based on an operation for giving an acceleration instruction to the vehicle 1 by at least one of the driver or an autonomous driving controller. The accelerator sensor 201 measures, for example, the accelerator position of the accelerator pedal 15 or the throttle position as the degree of acceleration. It should be noted that the acceleration herein refers to positive acceleration, which in other words is acceleration that results in an increase in speed. The autonomous driving controller may be the controller 100. The value indicating the degree of acceleration is referred to below as an “acceleration value”.

The brake sensor 202 measures the degree of deceleration based on an operation for giving a deceleration instruction to the vehicle 1 by at least one of the driver or the autonomous driving controller. The brake sensor 202 measures, for example, the brake position of the brake pedal 16 as the degree of deceleration. The value indicating the degree of deceleration is referred to below as a “deceleration value”.

The steering sensor 203 measures the direction change heading and the direction change degree based on an operation for giving a direction change instruction to the vehicle 1 by at least one of the driver or the autonomous driving controller. The steering sensor 203 measures, for example, the steering angle of the steering wheel 17 or the steering force in electric power steering as the direction change heading and the direction change degree. The value indicating the direction change degree is referred to below as a “direction change value”.

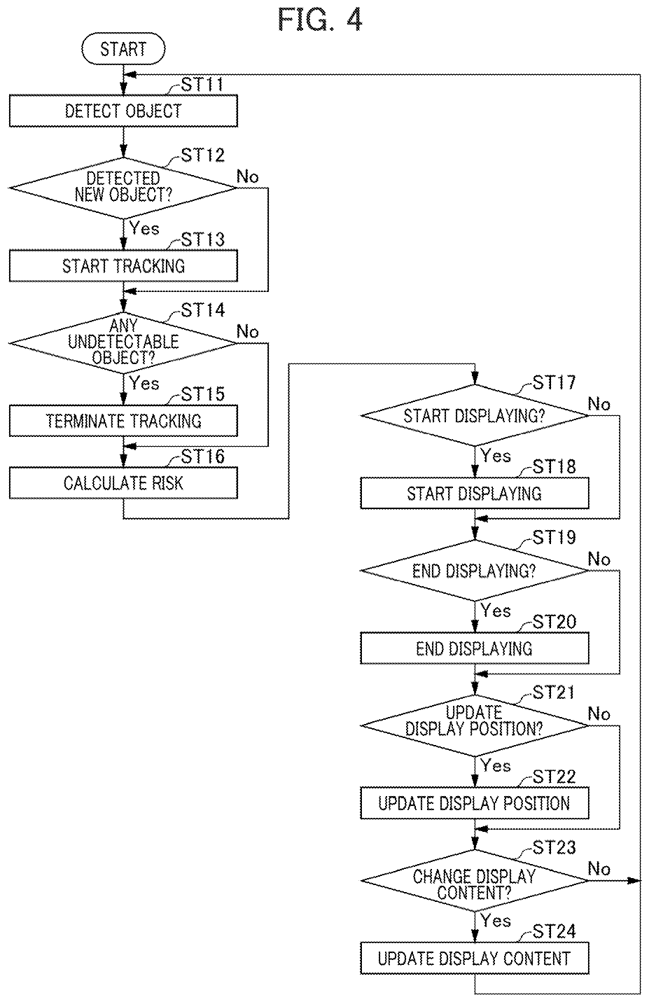

The following describes the operation of the vehicle 1 according to the present embodiment based on FIG. 4, etc. Processes in the following description of the operation are merely examples, and various processes that can achieve similar results may be employed as appropriate. FIG. 4 is a flowchart showing an example of processing to be executed by the processor 101 of the controller 100. The processor 101 executes, for example, the processing shown in FIG. 4 based on a program stored in the ROM 102 or the auxiliary storage device 104.

In Step ST11 in FIG. 4, the processor 101 of the controller 100 detects an object outside the vehicle 1 using the external sensor 21. The processor 101 also measures the position and the speed of the detected object using the external sensor 21. Preferably, in a case where there are multiple objects in the detection range of the external sensor 21, the processor 101 detects the multiple objects. Preferably, the processor 101 then measures the position and the speed for each of the multiple objects detected.

The processor 101 performs the process in Step ST11 as described above, and thus functions as an example of a detector that detects an object around a mobile object. Alternatively, the processor 101 performs the process in Step ST11 in cooperation with the external sensor 21, and thus functions as an example of the detector.

In Step ST12, the processor 101 determines whether or not a new object has been detected in Step ST11. Detecting a new object herein means detecting an object that is not a currently-tracked object. The tracking is described in association with the next step. If the processor 101 has detected a new object, the processor 101 determines that the result is Yes in Step ST12, and the processing continues to Step ST13.

In Step ST13, the processor 101 starts tracking the new detected object (tracking the position of the object). The processor 101 tracks, for example, the object using the external sensor 21. The object for which the tracking has been started is treated as a currently-tracked object.

After the processor 101 has finished the process in Step ST13, the processing continues to Step ST14. If the processor 101 has not detected a new object, the processor 101 determines that the result is No in Step ST12, and the processing continues to Step ST14.

In Step ST14, the processor 101 determines whether or not currently-tracked objects include any undetectable object. An undetectable object is, for example, one that is not detected in Step ST11. Alternatively, an undetectable object is one that is not detected in a certain number of executions of Step ST11. Alternatively, an undetectable object is one that is not detected in Step ST11 for at least a certain period of time. The processor 101 may treat an object for which the detection rate in a plurality of executions of Step ST11 is less than or equal to a predetermined value as an undetectable object. If the currently-tracked objects include an undetectable object, the processor 101 determines that the result is Yes in Step ST14, and the processing continues to Step ST15.

In Step ST15, the processor 101 terminates the tracking of the undetectable object among the currently-tracked objects. The object for which the tracking has been terminated is no longer treated as a currently-tracked object.

After the processor 101 has finished the process in Step ST15, the processing continues to Step ST16. If the currently-tracked objects do not include any undetectable object, the processor 101 determines that the result is No in Step ST14, and the processing continues to Step ST16.

In Step ST16, the processor 101 calculates values that indicate the level of risk involving the vehicle 1 and the objects outside the vehicle 1 (hereinafter “risk involving the vehicle 1 and the objects outside the vehicle 1” is referred to as “object risk”) (hereinafter “values that indicate the level of object risk” is referred to as “risk values”). Specifically, the processor 101 calculates risk values for each of the currently-tracked objects. The object risk is, for example, the danger of contact between the vehicle 1 and the object. It should be noted that a collision is a type of contact. The processor 101 calculates, for example, modified time-to-collision (mTTC) and modified time-to-closest-point-of-approach (mTCPA) as the risk values. The processor 101 calculates the risk values for each of the currently-tracked objects. Greater risk values may indicate a higher level of object risk, and smaller risk values may indicate a lower level of object risk.

The processor 101 calculates, for example, a velocity difference vd in accordance with an formula shown below. The velocity difference vd indicates the distance between the object and the vehicle 1 (host vehicle). The velocity difference vd indicates whether or not the host vehicle is likely to come into contact with the object.

$$vd = v\_f - v\_e \times ( 1 - b\_e ) \qquad ( 1 )$$

In the formula, v_f is the velocity of the object.
v_e is the velocity of the vehicle 1 (host vehicle).
b_e is the deceleration value of the host vehicle. It should be noted that b_e satisfies 0≤b_e≤1.

The processor 101 also calculates, for example, stop time St_f in accordance with an formula shown below. The stop time St_f indicates the time it takes for the object to stop.

$${St}_{f} = - 1 \times \frac{{v}_{f}}{{a}_{f}} \qquad ( 2 )$$

In the formula, a_f is the acceleration of the object.

The processor 101 also calculates, for example, mTTC in accordance with an formula shown below.

mTTC is time-to-collision (TTC) that takes into account at least one of an action or a state of the driver. TTC is the time it takes for the vehicle 1 to come into contact with the object that is estimated on the assumption that the current relative velocity between the object and the vehicle 1 is maintained. As such, the modified time-to-collision is the time it takes for the vehicle 1 to come into contact with the object that is estimated by taking into account the amount of decrease in the relative velocity estimated from at least one of an action or a state of the driver in addition to the current relative velocity between the object and the vehicle 1. The greater the value of mTTC is, the lower the level of risk is.

$$mTTC = \frac{- 1 \times vd - \sqrt{{vd}^{2} - 2 \times a\_f \times d}}{a\_f} \qquad ( 3 )$$

The processor 101 further calculates, for example, TTFSP in accordance with an formula shown below.

$$TTFSP = \frac{d - \frac{{v\_f}^{2}}{2 \times a\_f}}{v\_e \times ( 1 - b\_e )} \qquad ( 4 )$$

TTFSP indicates the distance between the object and the host vehicle that remains until the vehicle comes into contact with the object.

The processor 101 also calculates, for example, mTCPA in accordance with an formula shown below.

mTCPA is time-to-closest-point-of-approach (TCPA) that takes into account at least one of an action or a state of the driver. TCPA is the time it takes for the vehicle 1 to come closest to the object that is estimated on the assumption that the current relative velocity between the object and the vehicle 1 is maintained. As such, the modified time-to-closest-point-of-approach is the time it takes for the vehicle 1 to come closest to the object that is estimated by taking into account the amount of decrease in the relative velocity estimated from at least one of an action or a state of the driver in addition to the current relative velocity between the object and the vehicle 1.

$$mTC PA = \{ \begin{matrix}mTTC , & TTC\_ 1 D < St\_f \\ TTFSP , & TTC\_ 1 D \geq St\_f\end{matrix} \qquad ( 5 )$$

Specifically, the processor 101 determines mTCPA=mTTC if TTC 1D is less than St_f. The processor 101 determines mTCPA=TTFSP if TTC 1D is greater than or equal to St_f. TTC 1D herein indicates time-to-collision for the host vehicle with respect to the object. The greater the value of mTCPA is, the lower the level of risk is.

In the example described above, the processor 101 uses, for example, the extent to which the driver is applying the brakes as an action of the driver. For this purpose, the processor 101 calculates the stop time St_f, mTTC, and mTCPA using the deceleration value b_e of the host vehicle. The greater the deceleration value b_e of the host vehicle is, the shorter the stop time St_f is. The greater the deceleration value b_e of the host vehicle is, the greater mTTC is. The greater the deceleration value b_e of the host vehicle is, the greater mTCPA is.

The processor 101 may use, as a risk value, a value obtained by converting mTTC or mTCPA using a predetermined function. The processor 101 converts, for example, mTTC or mTCPA to a risk value that indicates a higher level of risk when the value is greater.

The processor 101 may calculate the risk values using an action or a state of the driver other than the extent to which the driver is applying the brakes.

(A1) to (A4) shown below are examples of actions or states of the driver that can be used to calculate the risk values other than the extent to which the driver is applying the brakes.

### (A1)

The processor 101 uses the extent to which the driver is applying the accelerator as an action or a state of the driver. For example, the processor 101 calculates risk values using the acceleration value of the host vehicle. The processor 101 calculates the risk values so that the level of risk increases with an increase in the acceleration value of the host vehicle.

### (A2)

The processor 101 uses the driver's operation for giving a direction change instruction to the vehicle 1 as an action or a state of the driver. For example, the processor 101 calculates risk values using the direction change heading and the direction change value. For example, the processor 101 calculates the risk values so that the level of risk decreases with an increase in the direction change value in a case where the direction change heading is away from the object for which the risk values are calculated. For example, the processor 101 calculates the risk values so that the level of risk is lower in a case where the direction change heading is away from the object for which the risk values are calculated than in a case where the direction change heading is toward the object for which the risk values are calculated.

### (A3)

The processor 101 uses the driver's line of sight as an action or a state of the driver. The processor 101 calculates the risk value so that the level of risk is lower in a case where the driver's line of sight is toward the object for which the risk values are calculated than in a case where the driver's line of sight is not toward the object.

### (A4)

The processor 101 uses, as an action or a state of the driver, the driver's awareness of the object for which the risk values are calculated. The processor 101 calculates the risk values so that the level of risk is lower in a case where the driver is determined to be aware of the object for which the risk values are calculated than in a case where the driver is determined to be unaware of the object. The processor 101 determines whether or not the driver is aware of the object using, for example, the driver's respiratory rate, heart rate, and line of sight. The processor 101 may calculate the risk values so that the level of risk decreases with an increase in the likelihood of the driver being aware of the object for which the risk values are calculated. For example, the processor 101 calculates the likelihood of the driver being aware of the object using the driver's movement, respiratory rate, heart rate, and line of sight.

The processor 101 may calculate the risk values using a plurality of actions or states of the driver.

The processor 101 performs the process in Step ST16 as described above, and thus functions as an example of a calculator that calculates the level of risk of contact between a mobile object and a detected object using at least one of an action or a state of an operator of the mobile object.

In Step ST17, the processor 101 determines, for each of objects that are currently tracked and that are not display targets, whether or not to select the object as a display target. For example, the processor 101 determines to select an object as a display target from among the objects that are currently tracked and that are not display targets, if the risk values of the object calculated in Step ST16 indicate a level of risk higher than a predetermined threshold value TH1. The number of objects to be selected as display targets may have an upper limit. The upper limit of the number of objects to be selected as display targets is referred to below as a “display limit”. In a configuration in which a display limit is set, the processor 101 ranks the objects in descending order of the level of risk indicated by the risk values and determines to select, as display targets, one or more objects that have a ranking lower than or equal to the value of the display limit and that have risk values indicating a level of risk higher than the predetermined threshold value TH1. The display limit is, for example, one, two, or more. If the processor 101 determines to select one or more objects as display targets from among the objects that are not display targets, the processor 101 determines that the result is Yes in Step ST17, and the processing continues to Step ST18.

In Step ST18, the processor 101 controls and causes the display 10 to start displaying information about each object selected as a display target in Step ST17 (hereinafter referred to as “object representation”). Using the object representation, the processor 101 notifies the driver of each object selected as a display target in Step ST17.

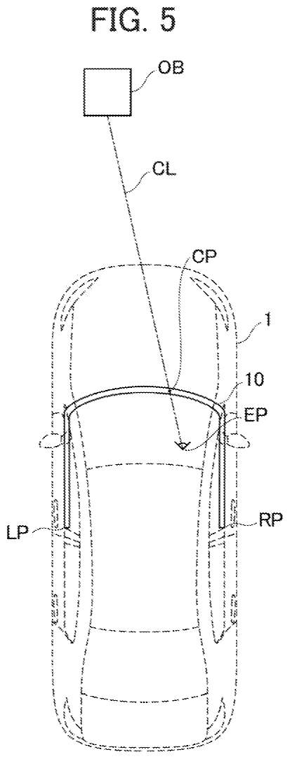

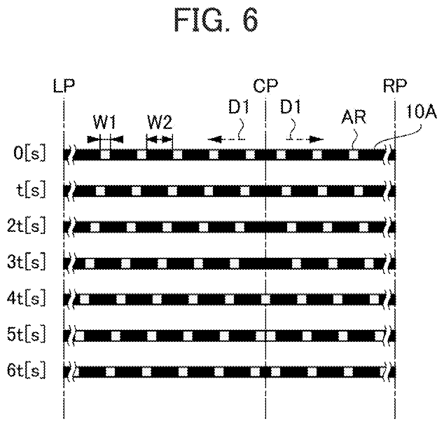

The following describes a manner in which the display 10 displays the object representation with reference to FIGS. 5 and 6. FIG. 5 is a diagram for describing a display position on the display 10. FIG. 6 is a diagram showing, in chronological order, an example of display content that is displayed in a display section 10A of the display 10.

The display 10 displays, for example, the object representation in such a manner that the direction of the object from the driver's perspective is recognizable. For this purpose, the processor 101 calculates a position CP. The position CP is the intersection of the display 10 and a vertical plane including a straight line CL connecting an eye position EP of the driver's eyes and the object, which is denoted by OB. The vertical plane can be defined, for example, as a plane perpendicular to the road, a plane perpendicular to the horizontal plane, or a plane parallel to the up-down direction of the vehicle 1.

The processor 101 measures, for example, the eye position EP using the in-vehicle sensor 20. The processor 101 may estimate the eye position EP from a body part position other than the eye position, such as a position of the driver's head. Alternatively, the body part position such as the position of the driver's head may be used as the eye position. The processor 101 measures the body part position other than the eye position using the in-vehicle sensor 20.

Alternatively, the processor 101 identifies the eye position EP using information preset by the driver or others. This preset information is, for example, the driver's height, sitting height, or driving posture. This information is, for example, stored in the auxiliary storage device 104. Alternatively, the processor 101 uses information indicating an average driver's eye position as the eye position EP. This information is, for example, stored in the auxiliary storage device 104.

It should be noted that FIG. 5 shows a left end of the display 10 as a position LP and the right end thereof as a position RP.

Typically, the actual display section 10A of the display 10 has a curved surface. FIG. 6 shows the display section 10A of the display 10 as a planar surface. FIG. 6 shows the display section 10A with portions thereof omitted. In a configuration in which the display 10 is a projector, the display section 10A is where an image or light is projected to.

As shown in FIG. 6, the object representation includes, for example, areas AR. The display 10 displays the areas AR with the position CP as a center in such a manner that the areas AR each move leftward or rightward away from the position CP as indicated by a direction D1. The display 10 displays the areas AR one after another. The areas AR are, for example, portions that emit light in a specific color and size or portions that are displayed in a specific color and size. In FIG. 6, white portions, which are the areas AR, are emitting light. Black portions are not emitting light. In a region on the left side of the position CP, the display of the areas AR starts at the position CP. These areas AR then each move leftward from the position CP, which is a movement starting position, to a movement end position. This movement end position is, for example, the position LP. In a region on the right side of the position CP, the display of the areas AR also starts at the position CP. These areas AR then each move rightward from the position CP, which is the movement starting position, to a movement end position. This movement end position is, for example, the position RP. It should be noted that the object representation preferably includes a representation that is line-symmetric with respect to a straight line passing through the position CP to make the direction of the object from the operator's perspective, which in other words is where the position CP is located, recognizable.

The display 10 displays the areas AR with the position CP as a center in such a manner that the areas AR each move leftward or rightward away from the position CP as indicated by the direction D1. This configuration can be described as a configuration in which the display 10 displays a representation in such a manner that predetermined areas of the representation each move from a position closer to a position corresponding to the direction of the object from the operator's perspective toward a position farther from the position corresponding to the direction of the object to make the direction of the object from the operator's perspective recognizable.

The following describes parameters of the object representation shown in FIG. 6. The vertical length of each area AR is the same as the vertical length of the display section 10A, and the lateral length of each area AR is a width W1 [m]. The distance between two adjacent areas AR is a width W2 [m] as long as these two areas AR do not have the position CP therebetween. Time t2 from the start of the display of an area AR to the start of the display of the next area AR is 7t [seconds]. Each area AR has a moving speed VA represented by ((W1+W2)/7t) [m/second].

The processor 101 may blink each area AR. Alternatively or additionally, the processor 101 may change the color of each area AR over time. For example, the processor 101 changes the color of each area AR in the order of a first color, a second color, . . . , and the nth color, and reverts the color of the area AR to the first color after reaching the nth color. The processor 101 then sequentially changes the color of the area AR again up to the nth color. It should be noted that n is an integer greater than or equal to 2. Alternatively or additionally, the processor 101 may display each area AR in such a manner that the moving speed VA changes over time. For example, the processor 101 may accelerate each area AR. For example, the processor 101 reduces or increases the moving speed VA as the area AR moves away from the position CP. This acceleration is referred to as an acceleration aA. Alternatively or additionally, the processor 101 may change the size of each area AR over time. For example, the processor 101 reduces or increases the size of the area AR as the area AR moves away from the position CP.

It should be noted that each area AR may move in a direction opposite to the direction D1. In the region on the left side of the position CP, the display of the areas AR starts at a movement starting position. These areas AR then each move rightward from the movement starting position to the position CP, which is a movement end position. This movement starting position is, for example, the position LP or between the position LP and the position CP. In the region on the right side of the position CP, the display of the areas AR starts at a movement starting position. These areas AR then each move leftward from the movement starting position to the position CP, which is a movement end position. This movement starting position is, for example, the position RP or between the position RP and the position CP.

The configuration in which the areas AR each move in a direction opposite to the direction D1 can be described as a configuration in which the display 10 displays a representation in such a manner that predetermined areas of the representation each move from a position farther from the position corresponding to the direction of the object from the operator's perspective toward a position closer to the position corresponding to the direction of the object to make the direction of the object from the operator's perspective recognizable.

The areas AR are not limited to being rectangular in shape. For example, the areas AR may be elliptical, triangular, arrow-shaped, or V-shaped.

Furthermore, some or all of the areas AR do not have to move. That is, some or all of the areas AR may be fixed relative to the position CP. In this case, the processor 101 displays the areas AR in such a manner that the driver or other occupants can recognize where the position CP is located. For this purpose, the processor 101 may employ, for example, triangular, arrow-shaped, or V-shaped areas AR. In this case, for example, the processor 101 displays the areas AR in such a manner that each area AR points in the direction of the position CP. Alternatively, the processor 101 may display areas AR that are line-symmetric with respect to a straight line passing through the position CP to allow the driver to recognize where the position CP is located.

The processor 101 determines each parameter of the object representation according to the risk values. Examples of how each parameter varies according to the risk values are shown below.

The processor 101 increases the size of the areas AR according to a higher level of risk.

The processor 101 increases the width W1 according to a higher level of risk.

The processor 101 increases the vertical length of the areas AR according to a higher level of risk.

The processor 101 reduces the width W2 according to a higher level of risk.

The processor 101 increases the moving speed VA according to a higher level of risk.

The processor 101 reduces the time t2 according to a higher level of risk.

The processor 101 increases the brightness of the areas AR according to a higher level of risk.

The processor 101 varies the color of the areas AR according to the level of risk. For example, the processor 101 displays the areas AR in blue if the risk values indicate a level of risk lower than a threshold value TH2. The processor 101 displays the areas AR in yellow if the risk values indicate a level of risk within a range of from the threshold value TH2 to a threshold value TH3. The processor 101 displays the areas AR in red if the risk values indicate a level of risk higher than the threshold value TH3. It should be noted that the threshold value TH3 corresponds to a higher level of risk than the threshold value TH2.

The processor 101 increases the rate of color change according to a higher level of risk.

The processor 101 continuously changes the color of the areas AR if the risk values indicate a level of risk higher than a threshold value TH4. The processor 101 does not change the color if the risk values indicate a level of risk lower than or equal to the threshold value TH4.

The processor 101 increases the acceleration aA according to a higher level of risk.

The processor 101 increases the blinking rate of the areas AR according to a higher level of risk.

The processor 101 varies the shape of the areas AR according to the level of risk.

When the display limit is two or more, the display 10 displays, for example, an object representation for each of multiple objects selected as display targets. The display 10 can display multiple object representations by, for example, displaying the multiple object representations on top of one another or displaying the multiple object representations in sequence.

The processor 101 performs the process in Step ST18 as described above, and thus functions as an example of a display controller that controls and causes a display to display a representation using parameters determined according to the level of risk of contact in such a manner that the direction of a detected object from the operator's perspective is recognizable.

After the processor 101 has finished the process in Step ST18, the processing continues to Step ST19. If the processor 101 determines not to select any object as a display target from among the objects that are not display targets, the processor 101 determines that the result is No in Step ST17, and the processing continues to Step ST19.

In Step ST19, the processor 101 determines whether or not to deselect any of the objects selected as display targets. For example, the processor 101 determines to deselect, from among the objects selected as display targets, an object that is no longer a tracking target, an object that has risk values indicating a level of risk lower than or equal to the threshold value TH1, and an object that has a ranking higher than the value of the display limit in descending order of the level of risk indicated by the risk values. If the processor 101 determines to deselect one or more of the objects selected as display targets, the processor 101 determines that the result is Yes in Step ST19, and the processing continues to Step ST20.

In Step ST20, the processor 101 controls and causes the display 10 to stop displaying the object representation corresponding to the deselected object(s).

Causing the display 10 to start displaying the object representation in Step ST18 before the process in Step ST20 can result in the number of display targets temporarily exceeding the display limit. The processor 101 may therefore only determine, for example, display content in Step ST18, and cause the display 10 to start actually displaying the object representation later than Step ST20.

After the processor 101 has finished the process in Step ST20, the processing continues to Step ST21. If the processor 101 determines not to deselect any of the objects selected as display targets, the processor 101 determines that the result is No in Step ST19, and the processing continues to Step ST21.

In Step ST21, the processor 101 determines whether or not to change the display position for any of the objects selected as display targets. The processor 101 calculates the position CP for each of the display targets. The processor 101 then determines to change the display position if the value of the position CP has changed from the previously calculated value. The processor 101 may determine to change the display position if the amount of change in the value of the position CP is greater than a predetermined value. The processor 101 may calculate the value of the position CP as a rounded value. If the processor 101 determines to change the display position for any of the objects selected as display targets, the processor 101 determines that the result is Yes in Step ST21, and the processing continues to Step ST22.

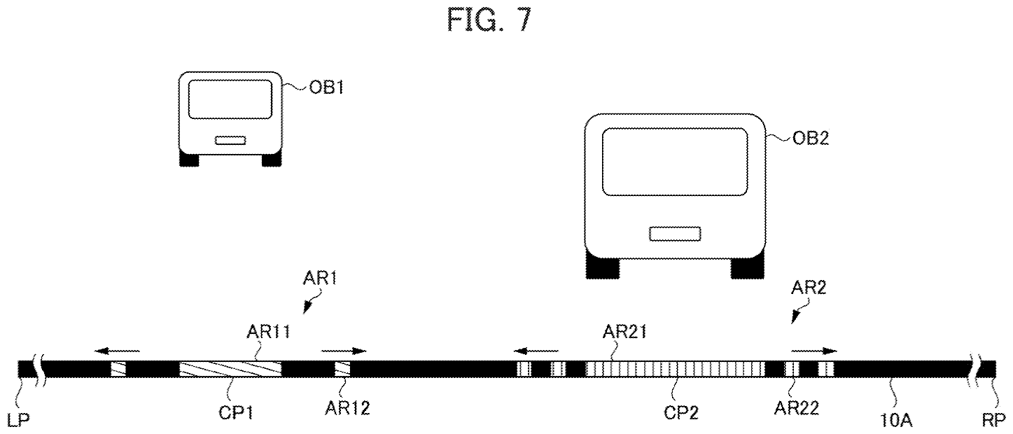

In Step ST22, the processor 101 changes the display position of the object representation to a position based on the value of the position CP newly calculated in Step ST21. The following describes the change of the display position of the object representation with reference to FIG. 7.

FIG. 7 is a diagram for describing the change of the display position and the change of the display content of the object representation. FIG. 7 shows an object OB1 and an object OB2 as the object OB. The object OB1 and the object OB2 represent the same object OB detected at different times. That is, the object OB1 represents the object OB as seen from the position EP at a specific time. The object OB2 represents the object OB as seen from the position EP at a time later than the specific time. This example is described on the assumption that the object OB moves straight from the position of the object OB1 to the position of the object OB2.

When the object OB is in the position of the object OB1, the object representation corresponding to the object OB includes areas AR1. The areas AR1 are displayed to form the object representation with a position CP1 on the display section 10A as a center. When the object OB is in the position of the object OB2, the object representation corresponding to the object OB includes areas AR2. The areas AR2 are displayed to form the object representation with a position CP2 on the display section 10A as a center. The areas AR1 and the areas AR2 are, for example, portions that emit light in a specific color and size or portions that are displayed in a specific color and size. The areas AR1 include an area AR11 and an area AR12. The areas AR2 include an area AR21 and an area AR22. The area AR11, the area AR12, the area AR21, and the area AR22 are examples of the areas AR. The position CP1 is the position CP corresponding to the object OB1. The position CP2 is the position CP corresponding to the object OB2. As will be appreciated from the foregoing, when the object OB moves from the position of the object OB1 to the position of the object OB2, which in other words is when the object OB moves rightward, the display position of the areas AR also shifts rightward. In practice, the processor 101 performs the process in Step ST22 multiple times while the object OB has moved from the position of the object OB1 to the position of the object OB2. The display position of the areas AR therefore gradually shifts from the position CP1 to the position CP2 in synchronization with the movement of the object OB.

After the processor 101 has finished the process in Step ST22, the processing continues to Step ST23. If the processor 101 determines not to change the display position for any of the objects selected as display targets, the processor 101 determines that the result is No in Step ST21, and the processing continues to Step ST23.

In Step ST23, the processor 101 determines whether or not to change the display content for any of the objects selected as display targets. The processor 101 determines to change the display content for an object representation if the parameters of the object representation according to the risk values calculated in the process in most recently performed Step ST16 are different from the currently set parameters. The currently set parameters are, for example, the parameters set according to the risk values calculated in previously performed Step ST16. If the processor 101 determines not to change the display content for any of the objects selected as display targets, the processor 101 determines that the result is No in Step ST23, and the processing returns to Step ST11. If the processor 101 determines to change the display content for one or more of the objects selected as display targets, the processor 101 determines that the result is Yes in Step ST23, and the processing continues to Step ST24.

In Step ST24, the processor 101 updates the display content of the object representation for each object for which the processor 101 has determined to change the display content. That is, for such an object representation, the processor 101 changes the currently set parameters to the parameters according to the risk values calculated in the process in most recently performed Step ST16. After the processor 101 has finished the process in Step ST24, the processing returns to Step ST11.

The following describes an example of the change of the display content with reference to FIG. 7. The object OB2 is closer to the vehicle 1 than the object OB1. The object OB2 therefore has higher risk values than the object OB1. The positions of the areas AR11 and AR21 are both fixed relative to the position CP. The areas AR11 and AR21 each have a rectangular shape that is line-symmetric with respect to a straight line passing through the corresponding position CP. The areas AR11 and AR21 have the same vertical length. The area AR21 has a longer horizontal length than the area AR11. As described above, the area AR21 has a larger size than the area AR11. That is, in the example shown in FIG. 7, the processor 101 increases the size of the area AR according to greater risk values.

The horizontal apparent length of the area AR11 as seen from the position EP is equal to the horizontal apparent width of the object OB1. The horizontal apparent length of the area AR21 as seen from the position EP is equal to the horizontal apparent width of the object OB2.

The areas AR12 and AR22 each move in a direction away from the corresponding position CP. The area AR22 moves faster than the area AR12. That is, in the example shown in FIG. 7, the processor 101 increases the moving speed of the area AR according to greater risk values.

The areas AR1 and the areas AR2 are different in color. That is, in the example shown in FIG. 7, the processor 101 varies the color of the areas AR according to change in the risk values.

In practice, the processor 101 typically performs the process in Step ST24 multiple times while the object OB has moved from the position of the object OB1 to the position of the object OB2. The size, the moving speed, and the color of the area AR therefore gradually change with change in the risk values of the object OB.

As described above, by repeating Steps ST11 to ST24, the processor 101 displays an object representation according to the level of risk for each detected object, and if there is a change in the level of risk, changes the display content of the object representation according to the level of risk calculated after the change.

The vehicle 1 according to the present embodiment detects an object around the vehicle 1. The vehicle 1 then calculates the level of risk of contact with the object around the vehicle 1 using at least one of an action or a state of the driver. Furthermore, the vehicle 1 displays a representation using the display 10 in such a manner that the direction of the object from the driver's perspective is recognizable. The vehicle 1 displays the representation using parameters according to the level of risk of contact. As such, the vehicle 1 according to the present embodiment can vary the manner of notification according to at least one of an action or a state of the driver. Thus, in a case where the driver is unaware of the object, for example, the vehicle 1 can display the representation in a more noticeable manner than in a case where the driver is aware of the object. The driver can find it disturbing if the representation is displayed in an overly noticeable manner even when the driver is aware of the object. The vehicle 1 according to the present embodiment makes it possible to prevent such disturbing display.

The vehicle 1 according to the present embodiment moves each area AR in the direction D1 or in a direction opposite to the direction D1. This configuration allows the driver to know the direction of the object even if the driver is looking in a different direction from the direction of the object.

The display 10 according to the present embodiment at least has a horizontal length extending from the A-pillar 12R to the A-pillar 12L. This configuration allows the vehicle 1 according to the present embodiment to display a representation in such a manner that the driver or other occupants can recognize at least the direction of an object within a range over which the windshield 11 extends from the driver's perspective.

The display 10 according to the present embodiment is, for example, a light emitting device disposed on the instrument panel 13. It is possible to dispose the light emitting device on the instrument panel 13 at a relatively low cost.

The display 10 according to the present embodiment is, for example, a projector that projects the display content onto the windshield. The configuration in which the display content is displayed on the windshield makes it easy for the driver to notice the display content.

The following modifications can be made to the foregoing embodiment. The foregoing embodiment has been described using an example in which the mobile object of the foregoing embodiment is an automobile. However, the mobile object of the foregoing embodiment may be other than an automobile. For example, the mobile object of the foregoing embodiment may be a motorcycle, a bicycle, a railroad vehicle, a ship, a submarine, an aircraft, or a spacecraft.

In the foregoing embodiment, the processor 101 implements the processes through programs. However, the processor 101 may implement some or all of the processes through a hardware configuration of a circuit.

The programs for implementing the processes according to the foregoing embodiment are transferred, for example, after being stored in a non-transitory storage medium in the device. However, the device may be transferred without the programs stored therein. In this case, the programs may be transferred separately from the device and later written to the device. The programs can be transferred, for example, by being recorded on a removable non-transitory storage medium or by being downloaded via a network such as the Internet or a local area network (LAN).

An embodiment of the present invention has been described above. However, the embodiment is merely an example and should not be construed to be limiting the scope of the present invention. The embodiment of the present invention may be implemented in various different forms that do not deviate from the gist of the present invention.

### EXPLANATION OF REFERENCE NUMERALS

1: Vehicle
10: Display
11: Windshield
12: A-pillar
13: Instrument panel
14 Side window
15: Accelerator pedal
16: Brake pedal
17: Steering wheel
18: Display device
19: Input device
20: In-vehicle sensor
21: External sensor
100: Controller
101: Processor
102: ROM
103: RAM
104: Auxiliary storage device
105: Communication interface
106: Control interface
201: Accelerator sensor
202: Brake sensor
203: Steering sensor

What is claimed is:

1. An attention guidance device comprising:
a detector configured to detect an object around a mobile object;
a calculator configured to calculate a level of risk of contact between the mobile object and the detected object using at least one of an action or a state of an operator of the mobile object; and
a display controller configured to control and cause a display to display a representation using parameters determined according to the level of risk of contact in such a manner that a direction of the detected object from the operator's perspective is recognizable.

2. The attention guidance device according to claim 1, wherein the display controller controls and causes the display to display a representation in such a manner that predetermined areas of the representation each move from a position farther from a position corresponding to the direction of the detected object from the operator's perspective toward a position closer to the position corresponding to the direction of the detected object or from a position closer to the position corresponding to the direction of the detected object toward a position farther from the position corresponding to the direction of the detected object, to make the direction of the detected object from the operator's perspective recognizable.

3. The attention guidance device according to claim 1, wherein the mobile object has a windshield and a pair of members holding left and right sides of the windshield, and
the display is disposed in a portion of the mobile object that includes an area extending from one of the pair of members to the other.

4. The attention guidance device according to claim 1, wherein the mobile object has an instrument panel, and
the display is a light-emitting device disposed on the instrument panel and including a light source.

5. The attention guidance device according to claim 1, wherein the mobile object has a windshield, and
the display includes a projector that projects display content onto the windshield.

6. An attention guidance system comprising a controller and a display,
the controller including:
a detector configured to detect an object around a mobile object;
a calculator configured to calculate a level of risk of contact between the mobile object and the detected object using at least one of an action or a state of an operator of the mobile object; and
a display controller configured to control and cause the display to display a representation using parameters determined according to the level of risk of contact in such a manner that a direction of the detected object from the operator's perspective is recognizable.

7. A non-transitory computer readable medium storing a program for causing a processor included in an attention guidance device to function as:
a detector configured to detect an object around a mobile object;
a calculator configured to calculate a level of risk of contact between the mobile object and the detected object using at least one of an action or a state of an operator of the mobile object; and
a display controller configured to control and cause a display to display a representation using parameters determined according to the level of risk of contact in such a manner that a direction of the detected object from the operator's perspective is recognizable.
